(19) United States
(12) Patent Application Publication
(10) Pub. No.: US 2022/0348517 A1
(43) Pub. Date: Nov. 3, 2022

(54) NOVEL CHEMISTRIES TO ACHIEVE A TOTAL AGRONOMIC COATING CONTAINING MICRONUTRIENTS AND/OR BIOCATALYSTS

(71) Applicant: ArrMaz Products Inc., Mulberry, FL (US)

(72) Inventors: Lucas R. Moore, Dover, FL (US); Christopher J. Holmes, Lakeland, FL (US); Anna McLeroy, Ft. Meade, FL (US); Michael Diaz, Mulberry, FL (US)

(73) Assignee: ArrMaz Products Inc., Mulberry, FL (US)

(21) Appl. No.: 17/730,937

(22) Filed: Apr. 27, 2022

Related U.S. Application Data
(60) Provisional application No. 63/180,753, filed on Apr. 28, 2021.

(51) Int. Cl. C05G 5/27; C05D 9/02; C05G 5/30; C05G 3/50; C05G 3/20

(52) U.S. Cl. CPC C05G 5/27; C05D 9/02; C05G 5/37; C05G 3/50; C05G 3/20

(57) ABSTRACT

A fertilizer coating that provides nutrients and/or biocatalysts, as well as added dust control and caking control. The fertilizer coating may comprise a carrier, one or more micronutrient dispersants, and one or more micronutrients. The carrier may be aqueous-based or oil based. The coating may further comprise one or more biocatalysts in an aqueous media.

### CROSS REFERENCE

This application is based on and claims priority to U.S. Provisional Application No. 63/180,753 filed Apr. 28, 2021.

### BACKGROUND OF THE INVENTION

### Field of the Invention

This invention relates generally to a fertilizer coating, and more particularly, but not by way of limitation, to a fertilizer coating providing nutrients, biocatalysts, biostimulants, dust control, and/or caking control.

### Description of the Related Art

Plant nutrients are classified as either macronutrients (N, P, K), secondary nutrients (Ca, S, Na, Mg), or micronutrients (Cu, Mn, Zn, B, etc.), in regards to traditional fertilizers. Fertilizers are often referred to by the macronutrient value, NPK, although there is often a need for other nutrients and/or biocatalysts to yield optimal crop growth and production. This has become a growing need in the industry.

Some producers will add nutrients during granulation to make a homogeneous granulated product. The issue here is that this is usually done with one component of the NPK (i.e. MAP), and thus the micronutrient will be diluted when the final blend is prepared. Another option is to blend micronutrient granules with the NPK granules; this, however, can be problematic due to the broad particle size range, variation in granule strength, and even possible increased caking tendencies, resulting in a negative downstream impact of not providing a homogeneous distribution of fertilizer over crop fields. Additionally, biocatalysts are sometimes used to enhance plant root uptake of these nutrients, which has become a growing need in the industry.

Based on the foregoing, it is desirable to provide an alternative option: “sticking” a fine micronutrient product to the granule surface at the warehouses or elsewhere by combining a coating containing micronutrients and/or biocatalysts with the fertilizer granules and tumbling/mixing together. This may allow for a higher concentration of micronutrients and/or biocatalysts on all components of the NPK, thus ensuring a more homogeneous distribution.

It is further desirable for the coating to offer dust control and caking control.

### SUMMARY OF THE INVENTION

In general, in a first aspect, the invention relates to a fertilizer coating comprising: a carrier; one or more micronutrient and/or nutrient dispersants and/or micronutrient surfactants; and one or more micronutrients and/or nutrients.

The carrier may be an aqueous-based carrier. The aqueous-based carrier, the one or more micronutrient dispersants, and the one or more micronutrients in the aqueous media may be emulsified with an oil-based media.

Alternately, the carrier may be an oil-based carrier. The fertilizer coating may further comprise one or more aqueous media, where the oil-based carrier, the one or more micronutrient dispersants, and the one or more micronutrients and the one or more aqueous media are emulsified.

In a second aspect, the invention relates to a method of providing micronutrients to fertilizer while reducing dust production and reducing caking tendencies. The method may comprise applying the coating described above to a fertilizer substrate. The coating may be applied to the fertilizer substrate by dosing a controlled amount of the coating onto the fertilizer substrates and tumbling or any desired mixing technique such as but not limited to, drum, ribbon blender, pug mill mixing. Alternately, the coating may be applied to the fertilizer substrate by applying the coating onto the fertilizer substrate as a top coat, without mixing.

In a third aspect, the invention relates to a method of producing fertilizer coating, the method comprising: adding micronutrients to an aqueous carrier; dispersing the micronutrients in the aqueous carrier; adding an oil-based media; and emulsifying the oil-based media and the aqueous carrier with dispersed micronutrients to produce the coating. Alternately, the method may comprise adding micronutrients to an oil-based carrier; dispersing the micronutrients in the oil-based carrier; adding an aqueous media; and emulsifying the aqueous media and the oil-based carrier with dispersed micronutrients to produce the coating. The coating may provide an additional nutrient load of 0.1% to 5% nutrient to a fertilizer to which the coating is applied Specifically, the micronutrients may comprise zinc oxide and the coating may comprise 40% to 80%, preferably 50% to 70%, more preferably 60% to 65%, more preferably 63% zinc oxide by weight. Additionally or alternately, the micronutrients may comprise zinc, copper, boron, iron, manganese, selenium, and/or other micronutrients or nutrients.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a fertilizer coating that provides nutrients and/or biocatalysts, as well as added dust control and/or caking control.

The fertilizer coating may be an aqueous-based micronutrient and/or biocatalyst coating. The aqueous-based coating may comprise an aqueous-based carrier, one or more micronutrient dispersants, and one or more micronutrients, which may form an aqueous-based coating. The coating may further comprise one or more biocatalysts in an aqueous media, which may be mixed with the aqueous-based coating.

The aqueous-based micronutrient and/or biocatalyst coating may then be emulsified with an oil-based media so that the final coating is either an oil-in-water emulsion or a water-in-oil emulsion. The coating may also potentially have solids added, which can help produce a pickering emulsion. The coating may also comprise biocides as modifiers. The coating may also comprise rheology modifiers.

Alternately, the fertilizer coating may be an oil-based micronutrient and/or biocatalyst coating. The oil-based coating may comprise an oil-based carrier, one or more micronutrient dispersants, and one or more micronutrients. The coating may further comprise one or more aqueous media that may or may not contain biocatalysts, where the one or more aqueous media, the oil-based carrier, micronutrient dispersants, and micronutrients may be emulsified into the coating. The resulting emulsion may either be an oil-in-water or a water-in-oil emulsion. The oil-based fertilizer coating may have a rheology modifier such as xanthum gum, guar gum, bentonite, fumed silica, or other solids. The aqueous-based coating may also have solids added, which can help produce a pickering emulsion. This can be achieved by adding xanthum gum, guar gum, bentonite, fumed silica, or other solids to help improve dispersion stability.

The fertilizer coating of the present invention may lead to the even distribution of a micronutrient and/or biocatalyst on all components of an NPK or single mineral or organic substrate blend. It may also lead to the ability to add higher concentrations of one or more micronutrients and/or provide one or more biocatalysts.

In addition to delivery of micronutrient and/or biocatalysts to fertilizers, the coating may also provide dust control and/or anticaking properties.

The fertilizer coating may be applied by producers, such as in fertilizer plants, or by blenders, such as in warehouses, by dosing a controlled amount of coating onto fertilizer granules and tumbling or any desired mixing technique such as but not limited to, drum, ribbon blender, pug mill mixing. Alternately, the coating may be applied as a top coat, without mixing.

Aqueous carriers may be water or a solution of water, which may include, but are not limited to: water, mineral water, glycols or polyglycols, alcohols and acids, or any combination thereof. In a preferred embodiment, a water solution with 10-90% glycol or polyglycol and 10-90% water may be beneficial for suspension of micronutrients. In particular, the aqueous carrier may be a water solution with 67% technical grade glycerin and 33% water; a combination of 62% technical grade glycerin and 38% water; a combination of 67% PEG 400 and 33% water; technical grade glycerin; other polyols, diols, triols, fatty acids, saponified fatty acids, or any other desired aqueous carrier. The aqueous carrier may be present in an aqueous-based micronutrient and/or biocatalyst coating at a rate of 0% by weight to 75% by weight. In particular, the aqueous carrier may be present in the aqueous-based micronutrient and/or biocatalyst coating at a rate of 16% by weight to 75% by weight.

Oil-based carriers may include, but are not limited to, any natural or modified oils or derivatives thereof such as naphthenic, paraffinic, triglycerides oils, triglycerides, tall oil or any plant or animal based or any combination thereof. In a preferred embodiment, a combination of 20% to 80% of any natural or modified plant-based oils such as canola oil or rapeseed and 20 to 80% tall oil pitch may be beneficial for suspension of micronutrients. In particular, the oil-based carrier may be a combination of 80% canola oil and 20% tall oil pitch or any other desired oil-based carrier. The oil-based carrier may be present in an oil-based micronutrient and/or biocatalyst coating at a rate of 0% by weight to 75% by weight. More particularly, the oil-based carrier may be present in an oil-based micronutrient and/or biocatalyst coating at a rate of 38% by weight to 68% by weight.

Micronutrient dispersants may include, but are not limited to, Rheocin, polyglycerol polyricinoleate, polyhydroxystearic acid, ethoxylated phosphate ester, acrylic acid/methacrylic acid, sodium dodecyl sulfate, polycondensed fatty acid, tall oil heads and rosin adduct (10% maleic anhydride), maleic acid/diisobutylene copolymer, lecithin, BOC polyhydroxystearic acid, BTC bentonite, polycarboxylate such as those produced from acrylic acid, maleic acid/anhydride, itaconic acid, methacrylic, sodium alkyl sulfonate, acrylamide, and hydroxyalkyl methacrylate or any combination of these monomers, any other desired micronutrient dispersants, or combinations thereof. To one skilled in the art, the micronutrient dispersants are better suited in the aqueous-based or the oil-based fertilizer coatings. The micronutrient dispersant may be present in the coating at a rate of 0.01% by weight to 5.00% by weight. More particularly, the micronutrient dispersant may be present in the coating at a rate of 0.34% by weight to 5.00% by weight.

Micronutrients may include, but are not limited to, zinc, copper, boron, and magnesium, or any other desired micronutrients. The micronutrients may be present in the coating at a rate of 20% by weight to 70% by weight. The micronutrients may comprise zinc, copper, boron, iron, manganese, selenium, and/or other micronutrients or nutrients. In particular, the micronutrient may be zinc and may be present in the coating at a rate of 63% zinc oxide by weight. The micronutrient may include not just oxides, but sulfates, carboxylate, and/or chelates.

If the fertilizer coating is an aqueous-based coating emulsified with oil, the oil may be, but is not limited to, any modified or natural desired oil or derivatives thereof, such as naphthenic, paraffinic, soy, triglycerides, tall oil, or any plant-based oil or any combination thereof. The oil may be present in the coating at a rate of 0 to 25% by weight. In particular, the oil may be present in the coating at a rate of 9 to 15% by weight.

Emulsifiers may include, but are not limited to, natural or modified fatty acids and polycondensed fatty acids, fatty acid esters and polyesters, petroleum/hydrocarbon based, and any derivatives or combination thereof. In preferred embodiment, ethoxylated phosphate ester may be used. The emulsifiers maybe present in the coating at a rate of 0.5% to 5.0% by weight, more particularly at a rate of 0.5 to 2.5% by weight, and even more particularly at a rate of 1% by weight.

Biocatalysts may include, but are not limited to, plant and other extracts, microbial agents, living organisms such as, for example, endophytes, fungi, yeasts, and bacteria, or other desired biochemical, biostimulants, or biologicals. Examples of biocatalysts may include one or more species from bacterial genu, such as, but not limited to, bacillu thizobium, azobacter, and azospirillu, one or more species from fungal genus or fungi such as aspergillus, mycorhizzae, Beauveria, metarhzium, and Trichoderma, and/or one or more species from a yeast genus such as Saccharomyces, Schizosaccharomyces, Sporobolomyces, Candida, Trichosporon, and thodosporidium. Other biologicals may not be microorganisms but rather may be small molecule and petide-based compositions such as metabolites, petides, lipopetides, hormones, metabolites, peptide hormones, siderophores, glycopeptides, humates, surfactants, vitamins, enzymes, amino acids, and amino acid derivatives, and nucleic acids and nucleic acid derivatives. In particular, biocatalysts may include Bacillus licheniformis (>0.01%) and may be present in the coating at a rate of 1% to 50% by weight, or more specifically 20% by weight, or alternately 4.13% by weight to 11.26% by weight. Other possible components may include anticaking agents, dispersants, colorants, odeur modifiers, or combinations thereof.

In particular, by way of example, the fertilizer coating may be an aqueous-based micronutrient and/or biocatalyst coating with one of the following compositions:

| | % by | | % by | Micronutrient | % by | Biocatalyst | % by |
|---|---|---|---|---|---|---|---|
| Aqueous Carrier | wt. | Dispersant Name | wt. | Name | wt. | Name | wt. |
| PEG 400 | 27.00 | Rheocin | 3 | Zinc Oxide | 70.00 | n/a | n/a |
| PEG 400 | 27.00 | Polyglycerol | 3 | Zinc Oxide | 70.00 | n/a | n/a |
| | | Polyricinoleate | | | | | |
| PEG 400 | 27.00 | Polyhydroxysteraric | 3 | Zinc Oxide | 70.00 | n/a | n/a |
| | | acid | | | | | |
| Technical Grade | 27.00 | Ethoxylated | 3 | Zinc Oxide | 70.00 | n/a | n/a |
| Glycerin 67%/ | | Phosphate Ester | | | | | |
| Water 33% | | | | | | | |
| Technical Grade | 27.00 | Acrylic acid/ | 3 | Zinc Oxide | 70.00 | n/a | n/a |
| Glycerin 67%/ | | Methacrylic acid | | | | | |
| Water 33% | | | | | | | |
| Technical Grade | 23.50 | Acrylic acid/ | 1:2.5 | Zinc Oxide | 70.00 | n/a | n/a |
| Glycerin 67%/ | | Methacrylic acid: | | | | | |
| Water 33% | | Sodium Dodecyl | | | | | |
| | | Sulfate | | | | | |
| Technical Grade | 27.00 | Acrylic acid/ | 3 | Zinc Oxide | 70.00 | n/a | n/a |
| Glycerin 62%/ | | Methacrylic acid | | | | | |
| Water 38% | | | | | | | |
| Water | 49.33 | 70% Sodium | 0.34 | Calcium | 50.00 | n/a | n/a |
| | | Dodecyl Sulfate | | Metaborate | | | |
| Technical Grade | 40 | Acrylic acid/ | 3 | Colemanite | 57.00 | n/a | n/a |
| Glycerin 67%/ | | Methacrylic acid | | | | | |
| Water 33% | | | | | | | |
| Technical Grade | 45.5 | Acrylic acid/ | 3 | Boric Acid | 51.5 | n/a | n/a |
| Glycerin 67%/ | | Methacrylic acid | | | | | |
| Water 33% | | | | | | | |
| Technical Grade | 54.0 | Acrylic acid/ | 3 | DiSodium | 43.0 | n/a | n/a |
| Glycerin 67%/ | | Methacrylic acid | | OctaBorate | | | |
| Water 33% | | | | Tetrahydrate | | | |
| Technical Grade | 46 | Acrylic acid/ | 3 | Copper II | 51.0 | n/a | n/a |
| Glycerin 67%/ | | Methacrylic acid | | Oxide | | | |
| Water 33% | | | | | | | |
| Technical Grade | 41.2 | Acrylic acid/ | 5 | Copper II | 53.8 | n/a | n/a |
| Glycerin 65.43%/ | | Methacrylic acid | | Oxide | | | |
| Water | | | | | | | |
| 34.07%/Xanthan | | | | | | | |
| Gum 0.5% | | | | | | | |
| Technical Grade | 27.16 | Acrylic acid/ | 5 | Copper II | 53.8 | Bacillus | 14.04 |
| Glycerin 99.26%/ | | Methacrylic acid | | Oxide | | Lichniformus | |
| Xanthan Gum | | | | | | (>1%) | |
| 0.74% | | | | | | | |
| Technical Grade | 49 | Acrylic acid/ | 5 | Copper II | 46 | n/a | n/a |
| Glycerin 65.43%/ | | Methacrylic acid | | Oxide | | | |
| Water | | | | | | | |
| 34.07%/Xanthan | | | | | | | |
| Gum 0.5% | | | | | | | |
| Technical Grade | 32.31 | Acrylic acid/ | 5 | Copper II | 46 | Bacillus | 16.69 |
| Glycerin 99.22%/ | | Methacrylic acid | | Oxide | | Lichniformus | |
| Xanthan Gum | | | | | | (>1%) | |
| 0.77% | | | | | | | |
| PEG 400 67%/ | 46 | Acrylic acid/ | 3 | Copper II | 51.00 | n/a | n/a |
| Water 33% | | Methacrylic acid | | Oxide | | | |
| Technical Grade | 16.74 | Acrylic acid/ | 3 | Zinc Oxide | 70.00 | Bacillus | 10.26 |
| Glycerin | | Methacrylic acid | | | | Lichniformus | |
| | | | | | | (>1%) | |
| Technical Grade | 18.09 | Acrylic acid/ | 3 | Zinc Oxide | 70.00 | Bacillus | 8.91 |
| Glycerin | | Methacrylic acid | | | | Lichniformus | |
| | | | | | | (>1%) | |
| Technical Grade | 36.0 | Acrylic acid/ | 3 | DiSodium | 43 | Bacillus | 18.0 |
| Glycerin | | Methacrylic acid | | OctaBorate | | Lichniformus | |
| | | | | Tetrahydrate | | (>1%) | |
| Technical Grade | 30.34 | Acrylic acid/ | 3 | Boric Acid | 51.5 | Bacillus | 15.16 |
| Glycerin | | Methacrylic acid | | | | Lichniformus | |
| | | | | | | (>1%) | |
| Technical Grade | 20.0 | Acrylic acid/ | 3 | Colemanite | 57.0 | Bacillus | 10.0 |
| Glycerin | | Methacrylic acid | | | | Lichniformus | |
| | | | | | | (>1%) | |

Alternately, by way of further example, the fertilizer coating may be an emulsified aqueous-based micronutrient and/or biocatalyst coating with the following composition:

| | % by | Dispersant | % by | Micronutrient | % by | Emulsifier | % by | | % by |
|---|---|---|---|---|---|---|---|---|---|
| Aqueous Carrier | wt. | Name | wt. | Name | wt. | Name | wt. | Oil | wt. |
| Tech Glycerin | 24.30 | Acrylic acid/ | 2.7 | Zinc Oxide | 63.00 | Ethoxylated | 1.00 | Canola Oil | 9.00 |
| 67%/Water | | Methacrylic | | | | Phosphate | | | |
| 33% | | acid | | | | Ester | | | |
| Tech Glycerin | 24.03 | Acrylic acid/ | 2.7 | Zinc Oxdie | 62.30 | Alkylphenol | 1.00 | Paraffin oil | 10.00 |
| 67%/Water | | Methacrylic | | | | Ethoxylate | | | |
| 33% | | acid | | | | | | | |
| Tech Glycerin | 24.03 | Acrylic acid/ | 2.7 | Zinc Oxdie | 62.30 | Alcohol | 1.00 | Paraffin oil | 10.00 |
| 67%/Water | | Methacrylic | | | | Ethyoxylate | | | |
| 33% | | acid | | | | | | | |
| Tech Glycerin | 24.03 | Acrylic acid/ | 2.7 | Zinc Oxdie | 62.30 | Alcohol | 1.00 | Canola oil | 10.00 |
| 67%/Water | | Methacrylic | | | | Ethyoxylate | | | |
| 33% | | acid | | | | | | | |
| Tech Glycerin | 44.0 | Acrylic acid/ | 3.0 | DiSodium | 43 | Ethoxylated | 1.0 | Canola oil | 9.00 |
| 67%/Water | | Methacrylic | | OctaBorate | | Phosphate | | | |
| 33% | | acid | | Tetrahydrate | | Ester | | | |
| Tech Glycerin | 35.5 | Acrylic acid/ | 3.0 | Boric Acid | 51.5 | Ethoxylated | 1.0 | Canola oil | 9.00 |
| 67%/Water | | Methacrylic | | | | Phosphate | | | |
| 33% | | acid | | | | Ester | | | |
| Tech Glycerin | 30.0 | Acrylic acid/ | 3.0 | Colemanite | 57.0 | Ethoxylated | 1.0 | Canola oil | 9.00 |
| 67%/Water | | Methacrylic | | | | Phosphate | | | |
| 33% | | acid | | | | Ester | | | |
| Tech Glycerin | 24.30 | Acrylic acid/ | 2.7 | Copper II | 63.00 | Ethoxylated | 1.00 | Canola Oil | 9.00 |
| 67%/Water | | Methacrylic | | Oxide | | Phosphate | | | |
| 33% | | acid | | | | Ester | | | |
| Technical Grade | 35.25 | Acrylic acid/ | 4.25 | Copper II | 46 | Ethoxylated | 1.5 | Canola Oil | 13 |
| Glycerin 65.39%/ | | Methacrylic | | Oxide | | Phosphate | | | |
| Water | | acid | | | | Ester | | | |
| 34.04%/Xanthan | | | | | | | | | |
| Gum 0.57% | | | | | | | | | |
| Technical Grade | 32.15 | Acrylic acid/ | 2.55 | Copper II | 52 | Ethoxylated | 1.3 | Canola Oil | 12 |
| Glycerin 66.25%/ | | Methacrylic | | Oxide | | Phosphate | | | |
| Water | | acid | | | | Ester | | | |
| 33.13%/Xanthan | | | | | | | | | |
| Gum 0.62% | | | | | | | | | |
| Technical Grade | 36.5 | Acrylic acid/ | 4 | Copper II | 45 | Ethoxylated | 1.5 | Canola Oil | 13 |
| Glycerin 65.21%/ | | Methacrylic | | Oxide | | Phosphate | | | |
| Water | | acid | | | | Ester | | | |
| 32.87%/Silica | | | | | | | | | |
| 1.92% | | | | | | | | | |

Alternately, by way of further example, the fertilizer coating may be an oil-based micronutrient and/or biocatalyst coating with one of the following compositions:

| | % by | | % by | | % by | | % by | | % by |
|---|---|---|---|---|---|---|---|---|---|
| Oil | wt. | Dispersant | wt. | Micronutrient | wt. | Emulsifier | wt. | Biocatalyst | wt. |
| Canola | 54.4 | Polycondensed | 3 | Zinc Oxide | 42.6 | n/a | n/a | n/a | n/a |
| Oil | | fatty acid | | | | | | | |
| Canola | 54.4 | Tall oil heads | 3 | Zinc Oxide | 42.6 | n/a | n/a | n/a | n/a |
| Oil | | | | | | | | | |
| Canola | 54.4 | 10% maleanized | 3 | Zinc Oxide | 42.6 | n/a | n/a | n/a | n/a |
| Oil | | Tall oil heads | | | | | | | |
| | | adduct | | | | | | | |
| Canola | 54.4 | Polyhydroxystearic | 3 | Zinc Oxide | 42.6 | n/a | n/a | n/a | n/a |
| Oil | | Acid | | | | | | | |
| Canola | 54.4 | Maleic Acid/ | 3 | Zinc Oxide | 42.6 | n/a | n/a | n/a | n/a |
| Oil | | diisobutylene | | | | | | | |
| | | copolymer | | | | | | | |
| Canola | 54.4 | Polyhydroxystearic | 3 | Zinc Oxide | 42.6 | n/a | n/a | n/a | n/a |
| Oil 80%/ | | Acid | | | | | | | |
| 20% Tall | | | | | | | | | |
| oil pitch | | | | | | | | | |
| Canola | 43.75 | Lecithin | 3 | Zinc Oxide | 53.25 | n/a | n/a | n/a | n/a |
| Oil 80%/ | | | | | | | | | |
| 20% Tall | | | | | | | | | |
| oil pitch | | | | | | | | | |
| 80%/ | 73.75 | BOC | 3 | Zinc Oxide | 53.25 | n/a | n/a | n/a | n/a |
| 20% RT | | Polyhydroxystearic | | | | | | | |
| 22000 | | Acid | | | | | | | |
| Canola | 38.00 | BTC Bentonite | 1 | Manganese | 61.00 | n/a | n/a | n/a | n/a |
| Oil 80%/ | | | | Carbonate | | | | | |
| 20% Tall | | | | | | | | | |
| oil pitch | | | | | | | | | |
| Canola | 40.00 | Polyhydroxystearic | 3 | Colemanite | 57.00 | n/a | n/a | n/a | n/a |
| Oil 80%/ | | Acid | | | | | | | |
| 20% Tall | | | | | | | | | |
| oil pitch | | | | | | | | | |
| Canola | 45.5 | Polyhydroxystearic | 3 | Boric Acid | 51.5 | n/a | n/a | n/a | n/a |
| Oil 80%/ | | Acid | | | | | | | |
| 20% Tall | | | | | | | | | |
| oil pitch | | | | | | | | | |
| Canola | 54 | Polyhydroxystearic | 3 | DiSodium | 43.0 | n/a | n/a | n/a | n/a |
| Oil 80%/ | | Acid | | OctaBorate | | | | | |
| 20% Tall | | | | Tetrahydrate | | | | | |
| oil pitch | | | | | | | | | |
| Canola | 46.00 | Polyhydroxystearic | 3 | Copper II | 51.00 | n/a | n/a | n/a | n/a |
| Oil 80%/ | | Acid | | Oxide | | | | | |
| 20% Tall | | | | | | | | | |
| oil pitch | | | | | | | | | |
| Canola | 63.56/ | Polyhydroxystearic | 2.85/ | Zinc Oxide | 28.46 | Ethoxylated | 1.00 | Bacillus | 4.13 |
| Oil 80%/ | 4.13 | Acid | 1.00 | | | Phosphate | | Lichniformus | |
| 20% Tall | | | | | | Ester | | (>1%) | |
| oil pitch | | | | | | | | | |

Applying a tailor-made coating that comprises a formulated micronutrient and/or biocatalyst package may allow higher levels of micronutrient loading per granule of fertilizer, as well as more nutrient and micronutrient adsorption, while also reducing the handling of dusty micronutrients at the warehouse and reducing dust throughout the supply chain. It may also reduce caking tendencies, which are commonly associated with mixing various mineral species that occurs by a decrease in critical relative humidity.

Whereas, the devices and methods have been described in relation to the drawings and claims, it should be understood that other and further modifications, apart from those shown or suggested herein, may be made within the spirit and scope of this invention.

What is claimed is:

1. A fertilizer coating comprising:
a carrier;
one or more micronutrient dispersants and/or micronutrient surfactants; and
one or more micronutrients.

2. The fertilizer coating of claim 1 where the carrier is an aqueous-based carrier.

3. The fertilizer coating of claim 2 where the aqueous-based carrier, the one or more micronutrient dispersants, and the one or more micronutrients are emulsified with an oil-based media.

4. The fertilizer coating of claim 2 further comprising an aqueous media further stabilized via a pickering emulsion.

5. The fertilizer coating of claim 1 where the carrier is an oil-based carrier.

6. The fertilizer coating of claim 5 where the oil-based carrier, the one or more micronutrient dispersants, and the one or more micronutrients are emulsified.

7. The fertilizer coating of claim 5 further comprising an oil phase stabilized through a rheological modifier.

8. A method of providing micronutrients to fertilizer while reducing dust production and reducing caking tendencies, the method comprising:
applying a coating to a fertilizer substrate, the coating comprising:
a carrier;
one or more micronutrient dispersants; and
one or more micronutrients.

9. The method of claim 8 where the carrier is an aqueous-based carrier.

10. The method of claim 8 where the coating further comprises of an aqueous media further stabilized via a pickering emulsion.

11. The method of claim 8 where the aqueous-based carrier, the one or more micronutrient dispersants, and the one or more micronutrients are emulsified with an oil-based media.

12. The method of claim 8 where the carrier is an oil-based carrier.

13. The method of claim 12 where the coating further comprises an oil phase stabilized through a rheological modifier.

14. The method of claim 12 where the oil-based carrier, the one or more micronutrient dispersants, and the one or more micronutrients are emulsified.

15. The method of claim 8 where the coating is applied to the fertilizer substrate by dosing a controlled amount of the coating onto a bed of the fertilizer substrate and tumbling or mixing.

16. The method of claim 8 where the coating is applied to the fertilizer substrate by applying the coating onto the fertilizer substrate as a top coat, without mixing.

17. A method of producing fertilizer coating, the method comprising:
adding micronutrients to an aqueous carrier;
dispersing the micronutrients in the aqueous carrier;
adding an oil-based media; and
emulsifying the oil-based media and the aqueous carrier with dispersed micronutrients to produce the coating.

18. The method of claim 17 where the micronutrients comprise zinc oxide and where the coating comprises 63% zinc oxide by weight.

19. A method of producing fertilizer coating, the method comprising:
adding micronutrients to an oil-based carrier;
dispersing the micronutrients in the oil-based carrier;
adding an aqueous media; and
emulsifying the aqueous media and the oil-based carrier with dispersed micronutrients to produce the coating.

20. The method of claim 19 where the coating provides an additional nutrient load of 0.1% to 5% nutrient to a fertilizer to which the coating is applied.

21. The method of claim 19 where the micronutrients comprise zinc oxide and where the coating comprises 63% zinc oxide by weight.
